(19) United States
(12) Patent Application Publication
(10) Pub. No.: US 2022/0106160 A1
(43) Pub. Date: Apr. 7, 2022

(54) SYSTEM AND METHOD FOR MAKING CONTACT-FREE ELEVATOR REQUESTS

(71) Applicant: OTIS ELEVATOR COMPANY, Farmington, CT (US)

(72) Inventors: Sam Thieu WONG, Farmington, CT (US); Vincent Refuerzo YBANEZ, West Haven, CT (US)

(21) Appl. No.: 17/061,631

(22) Filed: Oct. 2, 2020

(51) Int. Cl. B66B 1/46; B66B 1/34

(52) U.S. Cl. CPC B66B 1/468; B66B 2201/4653; B66B 2201/4638; B66B 1/3461

(57) ABSTRACT

An illustrative example embodiment of an elevator passenger interface system, includes a visual detector configured to detect a visible image that includes an indication of a request for elevator service. A processor interprets the indication and provides an output that is useable by an elevator system to control an elevator car to respond to the request for elevator service.

### BACKGROUND

Elevator systems are in widespread use for carrying passengers between various levels in buildings, for example. Access to an elevator car typically follows a passenger request for elevator service. One way in which passengers indicate a desired destination involves pressing a hall call button indicating a direction of travel and then pressing a floor indicator button on a car operating panel inside the elevator car. Other systems include a destination entry device that allows a passenger to indicate the desired destination prior to boarding the elevator car.

Many such systems require an individual to physically touch a button or touch screen. There are drawbacks to such systems especially when a communicable disease or virus is a public health concern, such as during a virus outbreak that becomes a pandemic.

Systems have been proposed that include wirelessly communicating a request for elevator service from a smart card or smart phone. Those systems address any concern an individual may have about physical contact with a passenger interface that others also touch, however, they cannot be easily implemented. For example, it is typically costly and complicated to retrofit a traditionally configured elevator system with wireless communication capability and to modify the controller to operate in response to wireless communications. Additionally, wireless communications have to meet regulations and may introduce potential cybersecurity concerns.

### SUMMARY

An illustrative example embodiment of an elevator passenger interface system, includes a visual detector configured to detect a visible image that includes an indication of a request for elevator service. A processor interprets the indication and provides an output that is useable by an elevator system to control an elevator car to respond to the request for elevator service.

In addition to one or more of the features described above, or as an alternative, the visual detector comprises one of a scanner, a camera or a reader.

In addition to one or more of the features described above, or as an alternative, the processor and the visual detector are part of a single device and the output provided by the processor is configured to be interpreted by an elevator system controller.

In addition to one or more of the features described above, or as an alternative, the visual detector provides a detector output to the processor that includes the indication, the processor interprets the indication to determine characteristics of the request for elevator service, and the processor is located remotely from the visual detector.

In addition to one or more of the features described above, or as an alternative, the elevator passenger interface system includes a visible image generator that is configured to generate an output that produces the visible image.

In addition to one or more of the features described above, or as an alternative, the visible image generator comprises one of a computing device or a smartphone.

In addition to one or more of the features described above, or as an alternative, the visible image generator provides a confirmation that the request for elevator service has been received by the elevator system.

In addition to one or more of the features described above, or as an alternative, the visible image includes an indication of a plurality of requests for elevator service and the processor is configured to use additional information associated with detection of the visible image by the visual detector to determine which of the plurality of requests for elevator service to include in the output provided by the processor.

In addition to one or more of the features described above, or as an alternative, the additional information comprises at least one of a time of day and a location of the detection of the visible image.

In addition to one or more of the features described above, or as an alternative, the visible image is valid to place the request for elevator service a plurality of times and the processor is configured to limit a number of uses of the visible image to place the request for elevator service within a window of time having a predetermined duration.

In addition to one or more of the features described above, or as an alternative, an elevator system includes the elevator passenger interface system of any of the previous paragraphs, an elevator controller that is configured to assign an elevator car to respond to the request for elevator service based on the output of the processor, and at least one indicator that is configured to indicate at least one of a confirmation that the request for elevator service has been received and an identification of the elevator car assigned to respond to the request for elevator service.

In addition to one or more of the features described above, or as an alternative, the elevator system includes at least one elevator car, the elevator passenger interface system includes a first visual detector situated outside the at least one elevator car and a second visual detector situated inside the elevator car, and the processor is configured to interpret the indication of the request for elevator service based on at least one of the first visual detector and the second visual detector detecting the visible image.

In addition to one or more of the features described above, or as an alternative, the elevator system is configured to serve a plurality of passengers, each of the passengers has a unique visible image to request elevator service, and the elevator controller is configured to determine a number of passengers receiving elevator service during a selected time interval.

In addition to one or more of the features described above, or as an alternative, the processor is integrated with the elevator controller.

An illustrative example embodiment of a method of facilitating an elevator passenger request for elevator service includes detecting a visible image that includes an indication of the request for elevator service, interpreting the indication by a processor, and providing an output from the processor that is useable by an elevator system to control an elevator car to respond to the request for elevator service.

In addition to one or more of the features described above, or as an alternative, detecting the visible image comprises using a visual detector that comprises one of a scanner, a camera or a reader.

In addition to one or more of the features described above, or as an alternative, the method includes providing a confirmation that the request for elevator service has been received by the elevator system.

In addition to one or more of the features described above, or as an alternative, the visible image includes an indication of a plurality of requests for elevator service and the method includes using additional information associated with detecting the visible image to determine which of the plurality of requests for elevator service to include in the output provided by the processor.

In addition to one or more of the features described above, or as an alternative, the additional information comprises at least one of a time of day and a location of the detection of the visible image.

In addition to one or more of the features described above, or as an alternative, the visible image is valid to place the request for elevator service a plurality of times and the method includes limiting a number of uses of the visible image to place the request for elevator service within a window of time having a predetermined duration.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system including a passenger interface system designed according to an example embodiment

FIG. 2 diagrammatically illustrates an example visible image generator.

FIG. 3 is a flow chart diagram summarizing an example method of facilitating passenger requests for elevator service.

### DETAILED DESCRIPTION

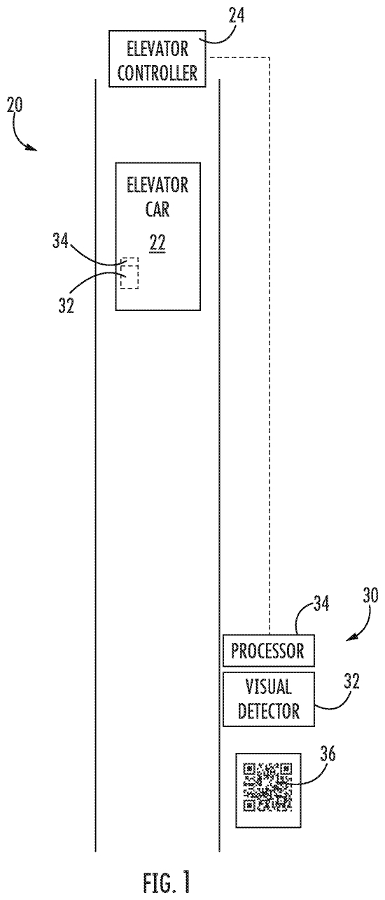

FIG. 1 schematically illustrates selected features of an elevator system 20. An elevator car 22, which may be one of several elevator cars in the system 20, provides elevator service to passengers. An elevator controller 24 controls movement of the elevator car 22 including, for example, assigning the elevator car 22 to fulfill certain passenger requests for elevator service using, for example, a known dispatching algorithm.

A passenger interface system 30 allows passengers to request elevator service in a contact-free manner. At least one visual detector 32 is configured to detect a visible image that includes an indication of a request for elevator service. A processor 34, which comprises at least one computing device, is associated with the visual detector 32. In the illustration, the processor 34 is schematically shown at or near the same location as the visual detector 32. In some embodiments, the processor 34 is remotely located from the visual detector 32. A remotely located processor 34 may be a computing device in the same building as the elevator system 20 or may be part of a cloud computing arrangement that is at least partially housed remote from the site of the elevator system 20. In some embodiments, the processor 34 is integrated with (or a portion of) the elevator controller 24.

In the illustrated example embodiment, a visual detector 32 is situated outside the elevator car 22 and another visual detector 32 is situated inside the elevator car 22 in this embodiment. Passengers may enter a request for elevator service through either visual detector 32. In some embodiments a traditional hall call button (e.g., up or down) is situated in the hallway outside the elevator car to place a call and a visual detector 32 inside the car allows for indicating the desired floor. An individual who boards the elevator car 22 in such an embodiment can use the detector inside the elevator car 22 in a manner that mimics using a car operating panel to indicate a desired destination. Other embodiments include visual detectors 32 only outside the elevator car 22 and passengers use such a system similar to a destination dispatching system in which passengers select the intended destination in the hallway and do not make a floor selection inside an elevator car.

The processor 34 is programmed or otherwise configured to interpret the indication of the visible image to determine the type of elevator service a passenger desires. In some embodiments, the visual detector 32 provides an output to the processor 34. The output is based on the detected visible image and includes some information regarding the indication of the request for elevator service. The processor 34 processes that output to determine what elevator service is being requested. In other embodiments, the visual detector passes along an image of the detected visible image to the processor 34 and the processor 34 is configured to interpret the content of the image.

The processor 34 generates an output that is useable by the elevator controller 24 to control the elevator car 22 to respond to the request for elevator service. The output from the processor 34 may be configured to be consistent with an elevator communication protocol used by the elevator controller 24 to respond to passenger requests made through another device. With such embodiments, it is possible to retrofit an existing elevator system to include a contact-free passenger interface system so passengers can make requests for elevator service without touching any surface that others may have touched.

An example visible image 36 includes a QR code that includes the indication of the request for elevator service. Other visible images include a bar code, a picture, a color, a number or a letter. A variety of image types can be used as an optically encoded request for elevator service having at least one feature that serves as an indication of a request for elevator service that can be interpreted by the processor 34. The visible image 36 may be created or generated in a variety of manners.

The visible image 36 may include an indication of security or credential information. Encryption may be used for any communications between the visual detector 32 and the processor 34 and any communications between the processor 34 and the elevator controller 24 to protect such information.

In some embodiments, each passenger has a unique indication or visible image. In other embodiments, the same visible image 36 may be used by more than one individual, with each individual having a respective device or item to present the image to the visual detector 32.

In the illustrated scenario, the visual detector comprises a scanner, camera or reader that is capable of recognizing the visible image and providing an output that includes the indication of the request for elevator service to the processor 34. The visual detector 32 is configured to detect and recognize at least one type of visible image and some visual detectors 32 are capable of detecting multiple image types.

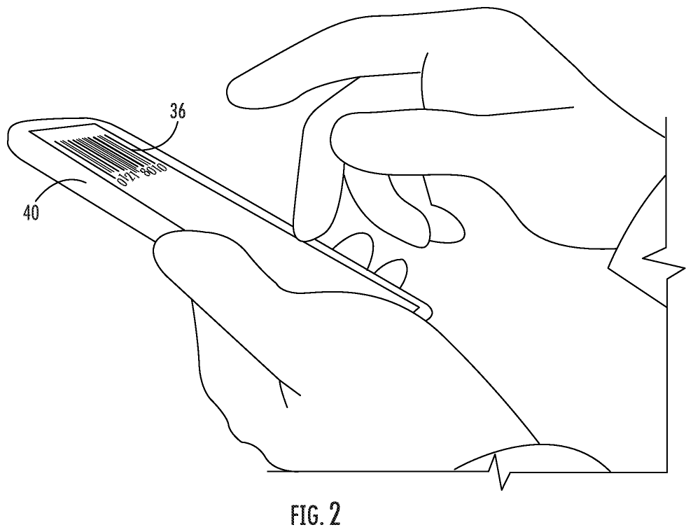

FIG. 2 shows an example visible image generator 40. In this example, a smartphone or other personal device generates the visible image 36 as a bar code. With such an image generator 40, the passenger may use an Internet connection to obtain or generate the image 36 when needed. In some embodiments, an application installed on a smartphone is configured to generate or otherwise present the visual image 36 without requiring an Internet connection. When the image 36 is reusable, it can be stored on the smartphone for repeated use.

For example, the passenger may have downloaded the application onto the smartphone and entered information that is encoded into the visible image 36 by the image generator 40. The passenger may provide information including the passenger's name, a building location or identifier, a default or preferred destination, alternative destinations, special accommodations or requests, and a number of individuals (if any) that will travel with the passenger on an elevator car. In some embodiments, the passenger need only enter a desired destination. The information may be entered using an interface provided through the downloaded application.

Other image generators include a computing device and printer that prints the visible image on a physical item, such as a piece of paper, sticker, or card. In such embodiments, the image generator may be at the site of the elevator system 20 or a remote location, such as in an individual's home or place of business. Some visible images are included on an individual's identification badge or building pass, which may be a card or fob, for example. In some such embodiments, the processor 34 is configured to interpret the information encoded in the visible image 36 to determine information regarding the passenger, such as authorization to travel to certain floors, and the intended destination. In some embodiments, the processor 34 has access to a database that includes such information regarding passengers that frequently use the elevator system 20, such as individuals who work or live in the building._{[GDJ1]}

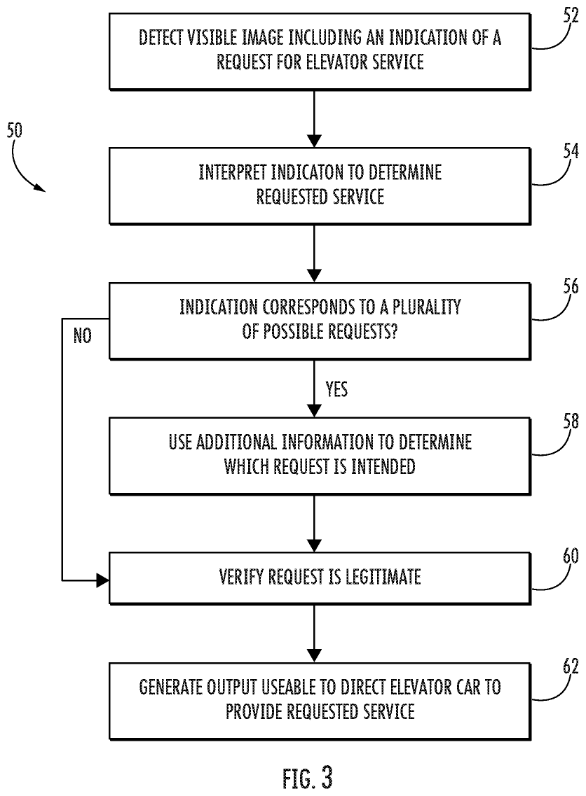

FIG. 3 is a flow chart diagram 50 summarizing an example method of facilitating passenger requests for elevator service. At 52, the visual detector 32 detects a visible image 36. At 54, the processor 34 interprets the indication of the request to determine the requested service. For example, the processor 34 interprets the indication to determine the intended destination of the passenger.

In some embodiments, a single visible image 36 may be used by an individual to request different destinations. At 56, the processor 34 determines whether more than one request is associated with the detected image 36. If the detected image 36 includes an indication of more than one possible request, the processor uses additional information at 58 to determine which request is being made. For example, the floor or location at which the visual detector 32 detects the image, the time of day, or both may be useful to determine which request is being made.

At 60, the processor 34 verifies the request_{[ADP2]}. The determination at 60 may include, for example, generating a feedback indication for the passenger regarding the determined request. Such feedback may be presented on the display of a smartphone, for example. The feedback may indicate which of several elevator cars has been assigned to the request and the destination floor. In some embodiments, if the passenger did not intend to place the request represented in the feedback or prefers a different elevator car, the passenger may cancel that request and rescan the visible image 36 or otherwise communicate the substitute request to the processor 34.

Another way in which a request may be verified at 60 includes determining whether the request has been made too many times within a window of time. For example, if an individual was uncertain that the visual detector 32 detected the visible image 36, that individual may repeatedly scan or present the image 36 to the visual detector 32. Alternatively, an individual may intentionally repeatedly present the image 36 to the visual detector 32 to avoid having others assigned to the same car. In such a repeated-detection situation, the processor 34 determines how many times the corresponding request was made within a period of time having a predetermined duration. If the number of requests within that window or period exceeds a threshold, at least some of those requests are ignored by the processor 34 to avoid unnecessary car assignments. For example, when the visual detector 32 repeatedly detects the same image at least three times within thirty seconds, the processor 34 treats only the first of the repeated detections as an actual request and disregards the others

Verifying the request at 60 also allows the processor 34 or the elevator controller 24 to track how many passengers are assigned to the elevator car 22 to avoid overcrowding the elevator car, for example.

In some embodiments, the visible image 36 is an encoded or encrypted elevator request that includes information regarding an identity or authorization of the individual making the request. Verifying the request at 60 may include determining that the individual making the request is authorized to travel to the intended destination.

When the request is verified, the processor 34 generates the output at 62 that is useable by the elevator controller 24 to assign and direct the elevator car 22 to provide the requested elevator service.

The illustrated example embodiment and other embodiments include contact-free interaction between a passenger and the elevator system 20 based on detecting an optically encoded request for elevator service so the individual passengers do not need to be concerned with contacting any surfaces that may be contaminated with a communicable disease, Embodiments consistent with the disclosed example may be included in new elevator systems or retrofit into existing elevator systems. The visual detector 32 and the processor 34 may be relatively low-cost components that make it economical to provide the benefits of such a passenger interface system.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator passenger interface system, comprising:
a visual detector configured to detect a visible image that includes an indication of a request for elevator service; and
a processor that interprets the indication and provides an output that is useable by an elevator system to control an elevator car to respond to the request for elevator service.

2. The elevator passenger interface system of claim 1, wherein the visual detector comprises one of a scanner, a camera or a reader.

3. The elevator passenger interface system of claim 1, wherein the processor and the visual detector are part of a single device and the output provided by the processor is configured to be interpreted by an elevator system controller.

4. The elevator passenger interface system of claim 1, wherein the visual detector provides a detector output to the processor that includes the indication, the processor interprets the indication to determine characteristics of the request for elevator service, and the processor is located remotely from the visual detector.

5. The elevator passenger interface system of claim 1, comprising a visible image generator that is configured to generate an output that produces the visible image.

6. The elevator passenger interface system of claim 5, wherein the visible image generator comprises one of a computing device or a smartphone.

7. The elevator passenger interface system of claim 6, wherein the visible image generator provides a confirmation that the request for elevator service has been received by the elevator system.

8. The elevator passenger interface system of claim 1, wherein the visible image includes an indication of a plurality of requests for elevator service and the processor is configured to use additional information associated with detection of the visible image by the visual detector to determine which of the plurality of requests for elevator service to include in the output provided by the processor.

9. The elevator passenger interface system of claim 8, wherein the additional information comprises at least one of a time of day and a location of the detection of the visible image.

10. The elevator passenger interface system of claim 1, wherein the visible image is valid to place the request for elevator service a plurality of times and the processor is configured to limit a number of uses of the visible image to place the request for elevator service within a window of time having a predetermined duration.

11. An elevator system, comprising:
the elevator passenger interface system of claim 1;
an elevator controller that is configured to assign an elevator car to respond to the request for elevator service based on the output of the processor; and
at least one indicator that is configured to indicate at least one of a confirmation that the request for elevator service has been received and an identification of the elevator car assigned to respond to the request for elevator service.

12. The elevator system of claim 11, comprising at least one elevator car and wherein
the elevator passenger interface system includes a first visual detector situated outside the at least one elevator car and a second visual detector situated inside the elevator car, and
the processor is configured to interpret the indication of the request for elevator service based on at least one of the first visual detector and the second visual detector detecting the visible image.

13. The elevator system of claim 11, wherein
the elevator system is configured to serve a plurality of passengers,
each of the passengers has a unique visible image to request elevator service, and
the elevator controller is configured to determine a number of passengers receiving elevator service during a selected time interval.

14. The elevator system of claim 11, wherein the processor is integrated with the elevator controller.

15. A method of facilitating an elevator passenger request for elevator service, the method comprising:
detecting a visible image that includes an indication of the request for elevator service;
interpreting the indication by a processor; and
providing an output from the processor that is useable by an elevator system to control an elevator car to respond to the request for elevator service.

16. The method of claim 15, wherein detecting the visible image comprises using a visual detector that comprises one of a scanner, a camera or a reader.

17. The method of claim 15, comprising providing a confirmation that the request for elevator service has been received by the elevator system.

18. The method of claim 15, wherein the visible image includes an indication of a plurality of requests for elevator service and the method includes using additional information associated with detecting the visible image to determine which of the plurality of requests for elevator service to include in the output provided by the processor.

19. The method of claim 18, wherein the additional information comprises at least one of a time of day and a location of the detection of the visible image.

20. The method of claim 15, wherein the visible image is valid to place the request for elevator service a plurality of times and the method includes limiting a number of uses of the visible image to place the request for elevator service within a window of time having a predetermined duration.
